(19) United States
(12) Patent Application Publication
(10) Pub. No.: US 2017/0243599 A1
(43) Pub. Date: Aug. 24, 2017

(54) Adaptive Closed Captioning

(71) Applicants: Shiyan Hu, Kanata (CA); Huaying Gao, Guangzhou City (CN)

(72) Inventors: Shiyan Hu, Kanata (CA); Huaying Gao, Guangzhou City (CN)

(73) Assignee: SYSU Huadu Industrial Science and Technology Institute, Guangzhou (CN)

(21) Appl. No.: 15/047,963

(22) Filed: Feb. 19, 2016

(51) Int. Cl. G10L 21/10; H04N 21/488; H04N 21/442; G10L 25/51

(52) U.S. Cl. CPC G10L 21/10; G10L 25/51; H04N 21/4884; H04N 21/442

(57) ABSTRACT

The present invention relates to a method for a user to adjust the contents of the closed-captioning based on a user's language skill and other needs. The method comprises the steps of: receiving closed captioning contents; determining sub-difficulty levels of the closed captioning contents by comparing the closed captioning contents with at least one classification database; grouping sub-difficulty levels based on preset ranges into difficulty levels; and displaying and adjusting closed captioning contents at difficulty levels chosen by the user.

### CROSS-REFERENCES TO RELATED APPLICATIONS

None

### TECHNICAL FIELD

The present invention relates to a mechanism for a user to adjust the contents of the closed-captioning based on a user's language skill and needs.

### BACKGROUND OF THE INVENTION

Closed captioning (CC) or subtitling refers to a method to display a text version of spoken contents on a television, video screen, or other visual displays to provide additional or interpretive information. CC was originally developed for hearing-impaired individuals, so that they can read the contents of what was broadcasted on screen, instead of listening to them. The use of CC has since been extended in a variety of situations. For instance, CC is usually turned on in a bar or in a gym, where the noise level is relative high. A person some distance away from the television may not be able to hear much, but he or she can still read the contents on the screen with reasonable clarity.

The term “closed” as in Closed Captioning refers to the fact that the captions are NOT visible until a user deliberately turns it on. Such an option comes built-in nowadays, usually via the remote control or menu options. Currently, only two options, either “on” or “off”, are available to the user, indicating with or without captions.

Closed Captioning data is usually embedded in the broadcast itself in a special format and in a special location of the video image. Most programs like televised movies, drama series, situation comedies, music videos, and documentaries, are captioned in advance of transmission. Others, such as live news broadcasts, require real time captioning, usually with the help of a trained stenographer. Live captioned data is then encoded into the broadcast signal continuously as the program airs. When a television receives broadcasting signals, the text becomes visible with the use of a decoder, either built into a television set or available as a set-top box. In general, an onscreen menu or a remote control device allows users to turn on or off closed captions.

In the United States, statistics from the National Captioning Institute suggested that the largest audience of CC was people whose native language was not English. CC is thus used as a tool by those learning to read and learning to speak English as a non-native speaker.

In order for CC to work effectively, the underlying assumption is that an user's speed of comprehension from listening and from reading is comparable, i.e., a user can match up and understand what was heard with what was read. Numerous scientific studies have shown that the speed of comprehension from listening and from reading is actually different for proficient native speakers. This discrepancy becomes even more pronounced for non-native speakers.

The present invention proposes a mechanism to allow a user to selectively configure and to adjust the difficulty level of words displayed in the CC in real time, as apposed to use the currently available “On” or “Off” option only.

### BRIEF SUMMARY OF EMBODIMENTS OF THE INVENTION

The present invention relates to a mechanism for a user to adjust the contents of the closed-captioning based on a user's language skill and other needs.

In a variant, the method for adjusting closed captioning contents by a user, comprising the steps of: receiving closed captioning contents; determining sub-difficulty levels of the closed captioning contents by comparing the closed captioning contents with at least one classification database; grouping sub-difficulty levels based on preset ranges into difficulty levels; and displaying and adjusting closed captioning contents at difficulty levels chosen by the user.

In another variant, the difficulty levels of closed caption contents are determined by: identifying a rate level of each word as classified by a Thorndike Word Classification Database; grouping rate levels into preset ranges of Easy, Medium, and Difficult; and displaying corresponding words only within the preset ranges as selected by the user.

In yet another variant, the difficulty levels of closed caption contents are determined by: identifying a grade level of each word as classified by a Dale and O'Rourke Word Classification Database; grouping grade levels into preset ranges of Easy, Medium, and Difficult; and displaying corresponding words only within the preset ranges as selected by the user.

In still another variant, the difficulty levels of closed caption contents are determined by: inputting a string of words and computing a Flesch Reading-Ease Score; grouping Flesch Reading-Ease Scores into preset ranges of Easy, Medium, and Difficult; and displaying corresponding string of words only within the preset ranges as selected by the user.

In a variant, the difficulty levels of closed caption contents are determined by: inputting a string of words and computing a first Flesch Reading-Ease Score; identifying known phrases from the string of words by comparing to a dictionary; computing a second Flesch Reading-Ease Score of the know phrases; grouping Flesch Reading-Ease Scores into preset ranges of Easy, Medium, and Difficult; and displaying corresponding string of words and phrases only within the ranges as selected by the user.

In another variant, the difficulty levels of closed caption contents are determined by: inputting a string of words and computing a first Flesch Reading-Ease Score; grouping Flesch Reading-Ease Scores into a first preset ranges of Easy, Medium, and Difficult; identifying a rate level of each word as classified by a Thorndike Word Classification Database; grouping rate levels into a second preset ranges of Easy, Medium, and Difficult; and displaying corresponding words only within the first and second preset ranges as selected by the user.

In yet another variant, the difficulty levels of closed caption contents are determined by: inputting a string of words and computing a first Flesch Reading-Ease Score; grouping Flesch Reading-Ease Scores into a first preset ranges of Easy, Medium, and Difficult; identifying a grade level of each word as classified by a Dale and O'Rourke Word Classification Database; grouping grade levels into a second preset ranges of Easy, Medium, and Difficult; and displaying corresponding words only within the first and second preset ranges as selected by the user.

In still another variant, the step of displaying and adjusting closed captioning contents further comprises: tracking a user's frequency of activation of a Hint option to display more contents; and increasing and decreasing the display of closed caption contents based on frequency increase and decrease of the user's activation of the Hint option.

In a variant, the step of displaying and adjusting closed captioning contents further comprises: tracking a user's frequency of activation of a Hint option to display more contents; determining a sub-difficulty level at which the Hint option is activated at the highest frequency; and displaying corresponding words at the sub-difficulty level and above.

In another variant, the step of grouping difficulty levels into preset ranges further comprises: tracking a user's frequency of activation of a Hint option to display more contents; and shifting the preset ranges of Easy, Medium, and Difficulty based on the frequency of activation of the Hint option.

In yet another variant, the step of displaying and adjusting closed captioning contents further comprises: tracking a user's frequency of activation of a Hint option to display more contents; compiling a list of words displayed via the activation of the Hint option; and providing a Summary function for the user to retrieve, to review and to translate the list of words.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates a standard symbol of Closed Captioning (CC) used by the broadcasting services.

FIG. 2a illustrates an exemplary text of a spoken passage displayed on the screen, when CC is turned on.

FIG. 2b illustrates an exemplary text of the same passage, where only selected words are displayed.

FIG. 3 is a table of an exemplary word rate level classification method used by Thorndike, E L, 1931.

FIG. 4 is a table of exemplary words and their corresponding rate levels classified by Thorndike, E L, 1931.

FIG. 5 illustrates an exemplary flow chart of the steps taken to classify words in CC based on the Thorndike rate level classification method.

FIGS. 6 a-d illustrate a same exemplary CC text passage with captioning level options set to Off, L1, L2, and L3, based on the Thorndike classification.

FIG. 7 illustrates the same exemplary CC text passage when a user presses the “Hint” button (or select the “Hint” option)

FIG. 8 is a table of exemplary English words with their associated score, based on Dale & O'Rourke, 1981.

FIG. 9 illustrates an exemplary flow chart of the steps taken to classify words in CC based on the Dale and O'Rourke classification method.

FIGS. 10 a-d illustrate a same exemplary CC text passage with captioning level options set to Off, L1, L2, and L3, based on the Dale and O'Rourke classification method.

FIG. 11 illustrates the same exemplary CC text passage when a user presses the “Hint” button (or select the “Hint” option).

FIG. 12 illustrates an exemplary flow chart of the steps taken to classify words in CC based on the Flesch reading-ease score.

FIGS. 13 a-d illustrate a same exemplary CC text passage with captioning level options set to Off, L1, L2, and L3, based on the Flesch reading-ease score.

FIG. 14 illustrates an exemplary flow chart of steps taken to calculate a Flesch reading-ease score for sentences/paragraphs in conjunction with short phrases (or idioms) in the CC.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

FIG. 1 illustrates a standard symbol of Closed Captioning (CC) used by the broadcasting services. Whenever “CC” is shown either via a remote control or via menu option, it indicates to a user that captioning or subtitling is available. A user, however, only has the “On” or the “Off” option.

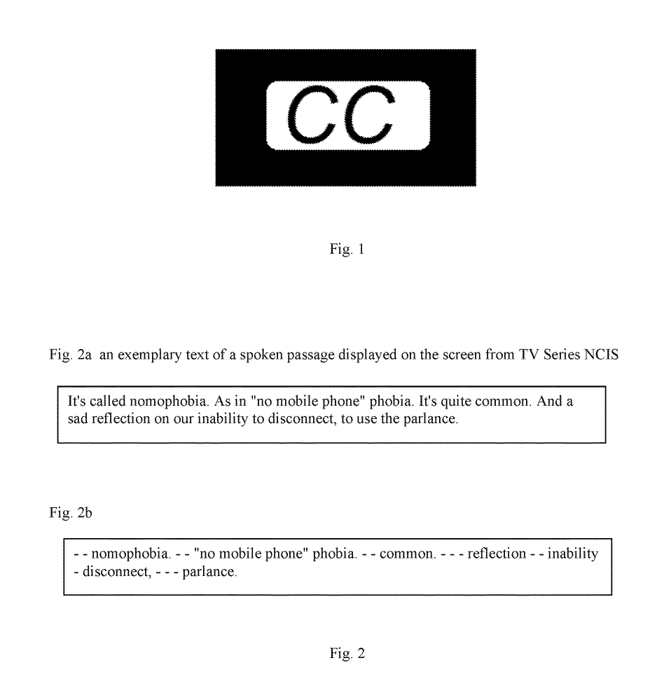

FIG. 2a illustrates an exemplary text of a spoken passage displayed on the screen, when CC is turned on. Due to the discrepancy of comprehension speed between reading and listening, a user may or may not be able to match up what was read with what was heard. For instance, a user who is focusing on listening may not catch every word in the sentence. Conversely, a user who is focusing on reading the CC may not hear anything the speaker said. A user who is switching between listening and reading mode may be forced to switch focus and attention constantly, with an end result of missing contents or simply fatigue. For a non-native speaker, this discrepancy is even more pronounced, due to the fact that non-native speakers often have a much smaller vocabulary. FIG. 2b illustrates an exemplary text of the same passage, where only selected words are displayed. More specifically, the structures of the sentences are preserved, but not all the words are displayed.

The present invention proposes a method to allow a user to display only words that are of a certain classified level. This method also allows a use to adjust these levels in real viewing time. We use the term “difficulty level” with its broadest reasonable interpretation, and refer to the general idea that a user can choose to display more difficult words based on his or her own level, and can opt to not display words that maybe less difficult.

We propose the following exemplary embodiments to classify words based on 1) word's difficulty; 2) word's grade level; and 3) readability level.

CC Display Based on Word's Difficulty

The difficulty level of a word can be measured based on one or more parameters, such as word length, frequency of use, and word grade level (at which school grade the word is introduced), etc. Among these parameters, high correlation between frequency of use and word difficulty is found and supported by research (Thorndike, E L, 1931; Klare, G R & Buck, B, 1954).

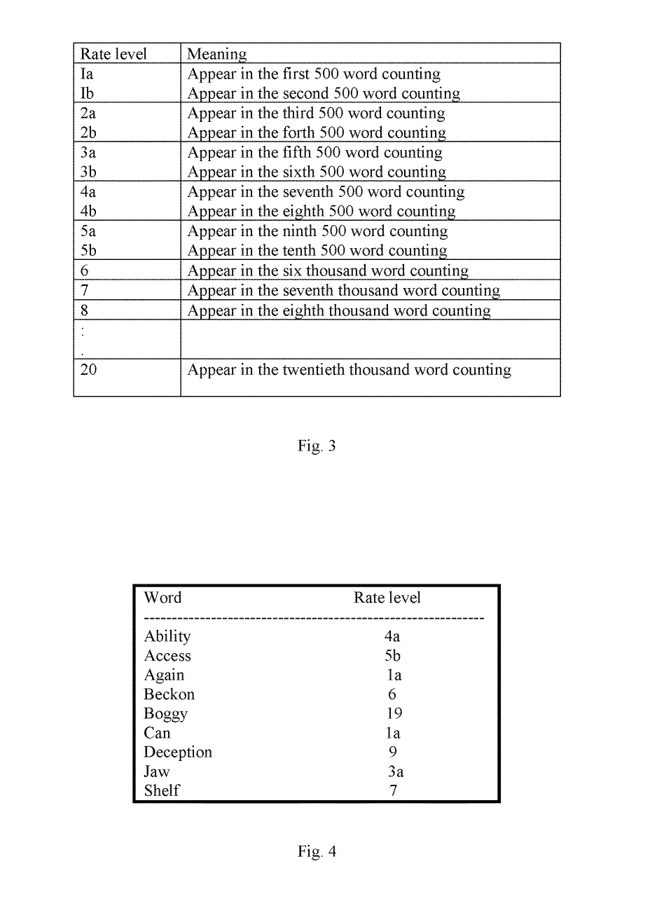

Thorndike, E L, 1931, estimated the frequency of usage of 20,000 common English words by counting more than 9 million words from various English books, literature for children, Bible, English classics, elementary school English textbooks, daily newspapers, and so on. Based on the frequency and range of occurrence of words, Thorndike assigned each word a rate level from 1 to 20. The meaning of each rate level is listed in a table in FIG. 3. Generally speaking, the words with lower rate level are used more frequently than the ones with higher rate level. An example of some English words and their rate levels is shown in FIG. 4 as classified by Thorndike.

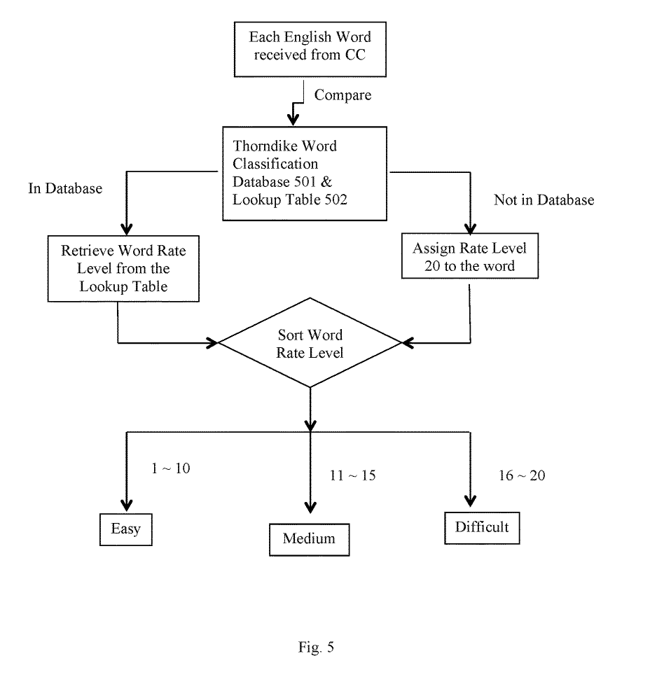

FIG. 5 illustrates an exemplary flow chart of the steps taken to classify words in CC based on the Thorndike classification method. A database 501 of the Thorndike classification of words and their rate level is preloaded and serves as a lookup table 502. Each English word received via CC is compared to the Thorndike word classification database 501 and the lookup table 502. If a word is found in the database, then its corresponding rate level is retrieved from the lookup table 502. If a word is not found in the database, then it is automatically assigned a level of 20.

According to the present invention, all words with rate levels from 1-10 maybe labeled as Easy in terms of difficulty, with higher frequency of use. All words with rate levels from 11-15 maybe labeled as Medium in terms of difficulty, with medium frequency of use. All words with rate levels from 16-20 maybe labeled as Difficult with low frequency of use. The numeric ranges such as 1-10 (Easy), 11-15 (Medium), and 16-20 (Difficult) can be changed based on a user's selection and activation pattern. Details of changing the ranges will be elaborated in sections below.

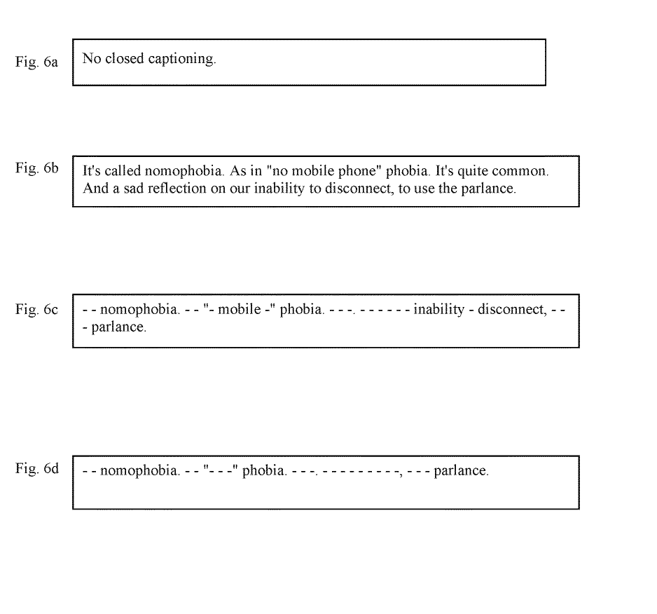

Based on the above rate level classifications, we may consider the following CC level options (via remote or via onscreen option menu): Off, L1, L2, L3, and Hint. FIGS. 6a-d illustrate a same exemplary CC text passage with captioning level options set to Off, L1, L2, and L3. By selecting the captioning level, a user is able to choose and adjust the amount of words to display on the screen based on the difficulty of the words used.

Off: Captioning is turned off, as illustrated in FIG. 6a;

L1: Level one captioning. Full captioning with all words displayed (rate level 1-20), as illustrated in FIG. 6b;

L2: Level two captioning. Words with rate levels of medium (11-15) and difficult (16-20) are displayed, as illustrated in FIG. 6c.

L3: Level three captioning. Words with rate level of difficult (16-20) are displayed, as illustrated in FIG. 6d.

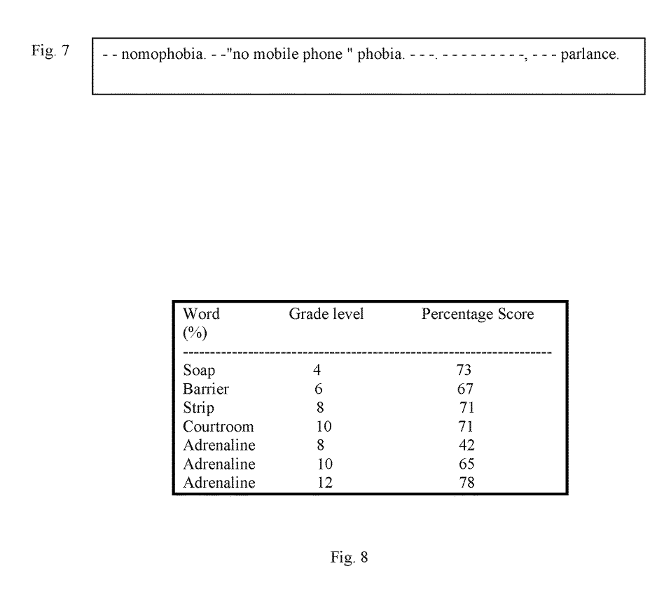

Hint: The “Hint” option is programed to allow a user to dynamically change the CC level options. If a user presses the “Hint” button (or select the “Hint” option), all contents of the CC are displayed within a pre-fixed time window. For instance, 1 second before, during, and after the “Hint” button is pressed (or the “Hint” option is selected). If a user increases the frequency of pressing the “Hint” button within a short period of time (10 minutes for example), the system will automatically adjust the CC level and display more words. FIG. 7 illustrates the same exemplary CC text passage when a user presses the “Hint” button (or select the “Hint” option) to display more text than the pre-set level L3 (as in FIG. 6d).

CC Display Based on Word's Grade Level

Apart from the frequency of use, difficulty of a word can also be measured based on at which school grade level the word is introduced. The logic behind such a classification is simply based on the fact that easier words are often introduced earlier in education. Dale and O″Rourke, 1981, employed a scheme with an alphabetic list of about 44000 items, each identified by a single word and its meaning. For each word, the list provided a grade level (4, 6, 8, 10, 12, 14, or 16) and a percentage score that indicated the percentages of students at that grade level who understood the word. Each word score was obtained by administering a three-item-multiple-choice test to students from schools and colleges throughout the United States. To reduce the bias, each word was tested with about 200 students at one or more above grades. A cut-off percentage score of 67% was used to determine the grade level of a word. Some example English words with their associated score are shown in FIG. 8. For example, 73% of grade 4 students understood the meaning of the word “soap”, and therefore Dale and O'Rourke labeled this word a 4^{th}-grade word. The word “Adrenaline” was tested three times with grade 8, 10, and 12 students separately. The test results showed that 42% of Grade 8 students, 65% of Grade 10 students, and 78% of Grade 12 students correctly understood the meaning of this word. Based on the 67% cut-off criteria, the word “Adrenaline” was labeled as a 12^{th}-grade word.

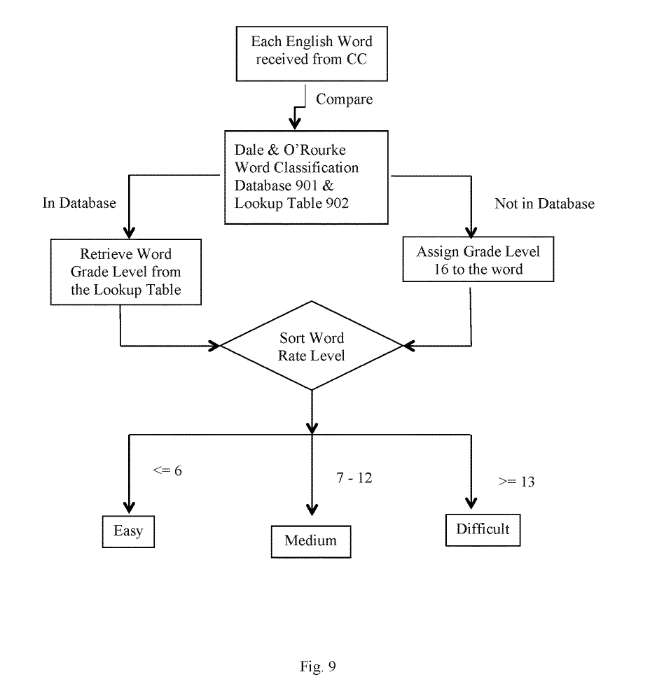

FIG. 9 shows an exemplary flow chart of the steps taken to classify words in CC based on the Dale and O'Rourke classification method. A Database 901 of the Dale and O'Rourke classification of words and their grade level is preloaded and serves as a lookup table 902. Each word received via CC is compared to the lookup table 902. If a word is found in the lookup table, then its corresponding grade level is retrieved. If a word is not found in the table, then it is automatically assigned a level of 16.

According to the present invention, all words with grade levels up to the 6^{th} grade maybe labeled as Easy in terms of difficulty. All words with grade levels from 7-12^{th} grade maybe labeled as Medium in terms of difficulty. All words with grade levels above 12^{th} grade maybe labeled as Difficult. The numeric ranges such as 1-6 (Easy), 7-12 (Medium), and >12 (Difficult) can be changed based on a user's selection and activation pattern. Details of changing the ranges will be elaborated in sections below.

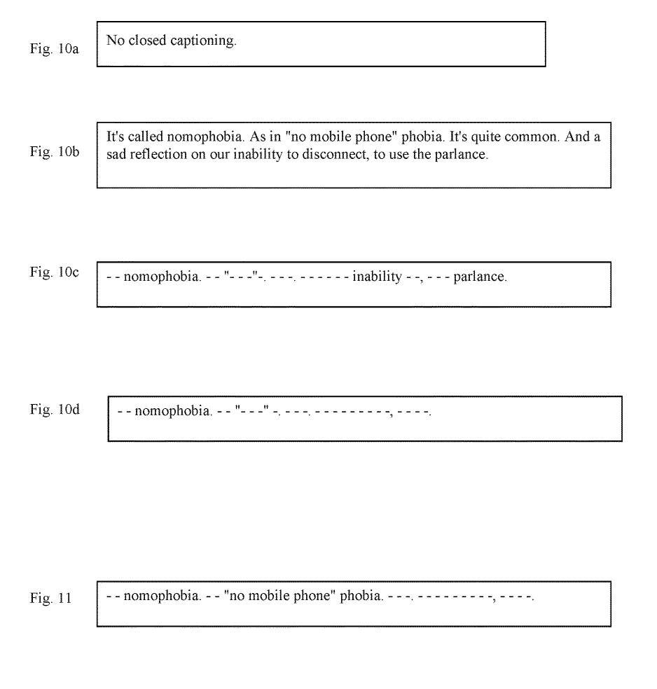

Based on the above rate level classifications, we may consider the following CC level options (via remote or via onscreen option menu): Off, L1, L2, L3, and Hint. FIGS. 10 a-d illustrate a same exemplary CC text passage with captioning level options set to Off, L1, L2, and L3. By selecting the captioning level, a user is able to choose and adjust the amount of words to display on the screen based on the difficulty of the words used.

Off: Captioning is turned off, as illustrated in FIG. 10a;

L1: Level one captioning. Full captioning with all words displayed (grade level 1-6), as illustrated in FIG. 10b;

L2: Level two captioning. Words with grade levels of medium (7-12) and difficult (13 and above) are displayed, as illustrated in FIG. 10c.

L3: Level three captioning. Words with grade level of difficult (13 and above) are displayed, as illustrated in FIG. 10d.

Hint: The “Hint” option is programed to allow a user to dynamically change the CC level options. If a user presses the “Hint” button (or select the “Hint” option), all contents of the CC are displayed within a pre-fixed time window. For instance, 1 second before, during, and after the “Hint” button is pressed (or the “Hint” option is selected). If a user increases the frequency of pressing the “Hint” button within a short period of time (10 minutes for example), the system will automatically adjust the CC level and display more words. FIG. 11 illustrates the same exemplary CC text passage when a user presses the “Hint” button (or select the “Hint” option) to display more text than the pre-set level L3 (as in FIG. 10d).

CC Display Based on Readability Level

In the previous sections, we discussed options of determining the difficulty level of single words or vocabularies. In reality, words often appear as part of a phrase or within some context, such as sentences and paragraphs. The Flesch-Kincaid readability test (Kincaid, J P, Fishburne, R P, Rogers, R L, and Chissom, B S, 1975) is designed to gauge how difficult a reading passage in English is to be understood. Readability of a sentence or a paragraph is determined by two variables: the complexity of the sentence construction and the complexity of the vocabulary. Based on those two variables, Kincaid and his team developed the Flesch-Kincaid readability formula to access the complexity of an English passage or sentence through calculating its Flesch reading-ease score. In the formula:

$$206.835 - 1.015 \times ( total words ) - 84.6 ( \frac{total syllables}{total words} ) ,$$

the complexity of the sentence construction is evaluated by sentence length, and the complexity of vocabulary is evaluated by the number of syllables in each word. The Flesch reading-ease score varies from 0 to 100. Generally speaking, higher scores indicate material that is easier to read; lower scores indicate passages that are more difficult to read. A rough interpretation of the different scores can be described as follows:

90-100: easily understood by an average 11-year-old student

60-70: easily understood by 13 to 15 year old students

0-30: best understood by university gradates

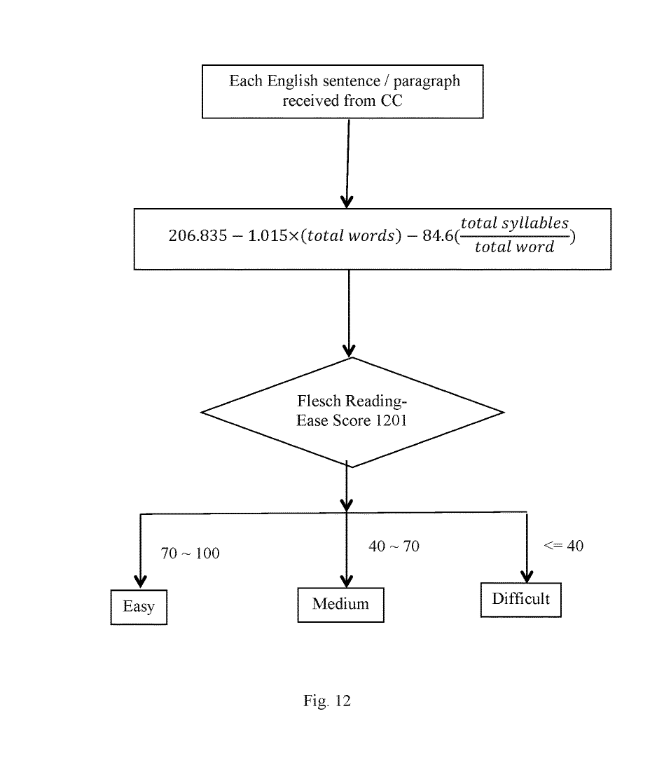

FIG. 12 illustrates an exemplary flow chart of the steps taken to classify words in CC based on the Flesch reading-ease score. Each English sentence/paragraph received from CC is used to compute a Flesch Reading-Ease Score 1201.

According to the present invention, all sentences/paragraph with a Reading-Ease Score between 70-100 maybe labeled as Easy in terms of difficulty. All sentences/paragraph with a Reading-Ease Score between 40-70 maybe labeled as Medium in terms of difficulty. All sentences/paragraph with a Reading-Ease Score below 40 maybe labeled as Difficult. The numeric ranges such as 70-100 (Easy), 40-70 (Medium), and <40 (Difficult) can be changed based on a user's selection and activation pattern. Details of changing the ranges will be elaborated in sections below.

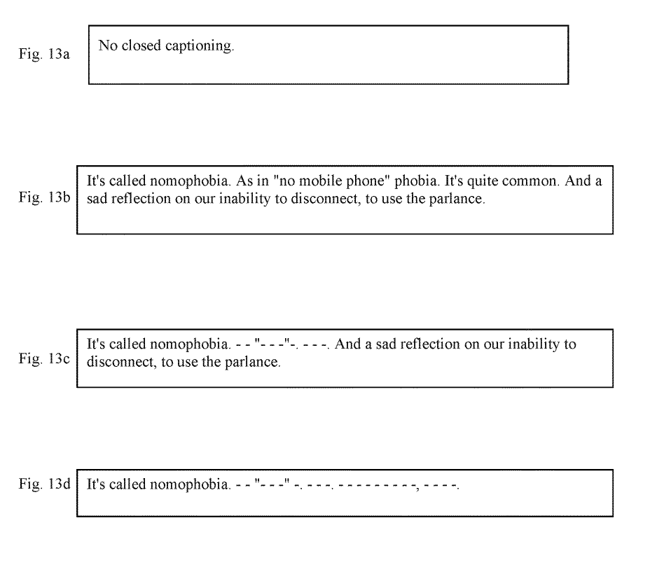

Based on the above Reading-Ease Score, we may consider the following CC level options (via remote or via onscreen option menu): Off, L1, L2, L3, and Hint. FIGS. 13 a-d illustrate a same exemplary CC text passage with captioning level options set to Off, L1, L2, and L3. By selecting the captioning level, a user is able to choose and adjust the amount of words to display on the screen based on the difficulty of the words used.

Off: Captioning is turned off, as illustrated in FIG. 13a;

L1: Level one captioning. Full captioning with all words displayed, as illustrated in FIG. 13b;

L2: Level two captioning. Words with Reading-Ease Scores of medium (40-70) and difficult (40 and below) are displayed, as illustrated in FIG. 13c.

L3: Level three captioning. Words with Reading-Ease Scores of difficult (40 and below) are displayed, as illustrated in FIG. 13d.

Hint: The “Hint” option is programed to allow a user to dynamically change the CC level options. If a user presses the “Hint” button (or select the “Hint” option), all contents of the CC are displayed within a pre-fixed time window. For instance, 1 second before, during, and after the “Hint” button is pressed (or the “Hint” option is selected). If a user increases the frequency of pressing the “Hint” button within a short period of time (10 minutes for example), the system will automatically adjust the CC level and display more words.

Two variables in the Flesch-Kincaid readability formula are “total words” and “total syllables”. In the previous examples, we demonstrated an application of the formular to sentences and to paragraphs. This formular, however, can also be applied to short phrases, where one can calculate a Flesch-Kincaid reading ease score by inputting a short phrase (or idiom).

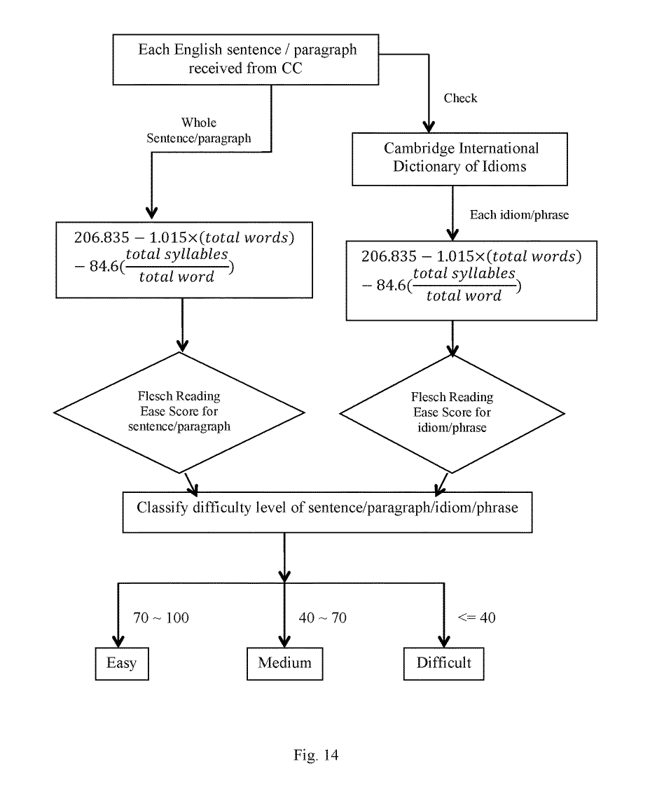

FIG. 14 illustrates an exemplary flow chart of steps taken to calculate a Flesch reading-ease score for sentences/paragraphs in conjunction with short phrases (or idioms) in the CC.

In this example, a Cambridge International Dictionary of Idioms is pre-loaded into the system. Contents received via CC are compared to the Dictionary for identification purposes. When a short phrase or idiom is identified, it is used to compute a Flesch reading ease score the same way a sentence or a paragraph is used. The resulting score is then used to classify a phrase/idiom into Easy, Medium, and Difficult levels. Sentences/paragraphs or phrases/idioms with reading ease scores falling into the corresponding classification ranges will be displayed.

The above example also illustrates that the methods discussed in the previous sections can be combined. For instance, the Flesch readability method can be combined with the Thorndike method in either a parallel or a serial manner. A sentence/paragraph with a classified difficulty level can have each word in the sentence further classified based on the Thorndike method. This is particularly useful when a short or less complex sentence contains difficult or less frequently used words. By the same token, the Flesch readability method can also be combined with the Dale and O'Rourke method in parallel or in serial to display words that are difficult based on grade introduction levels, independent from how complex the sentence itself is.

Self-Learning Based Captioning Selection

We have discussed the Hint option in the previous sections where a user can choose to display more or less words in the CC, by using the Hint function repeatedly within a preset time window. This option can be further elaborated to track a user's pattern of CC activation and automatically assess a user's comprehension level over an extended period of time. For instance, if a user frequently activates the caption for certain words via the Hint option, the present invention is programed to automatically open captions for words at a similar difficulty level.

As illustrated via the Thorndike method, if the Hint option is frequently activated around rate level 13, all words rated level 13 and above will be displayed, bypassing the Easy, Medium, and Difficult classification process all together. Similar approaches can be used in the Dale & O'Rourke and the Flesch methods. In essence, captioning level options of Off, L1, L2, and L3, are further fleshed out into sub-levels, such as rate level 13 in the previous example. If a sublevel is identified, words of the same difficulty in the same sublevel and above (or more difficult) are all displayed.

By tracking a user's pattern of CC activation and assessing a user's comprehension level over an extended period of time, the present invention can also be programed to increase the difficulty levels of the CC contents to display. More specifically, if the Hint Option is NOT activated for an extended period of time, a user is offered a choice to remain at the level, or to increase the difficulty level of the CC display. Alternatively, the present invention is programed to automatically adjust the difficulty levels and sublevels of the CC contents based on the inactivity of the Hint option.

As discussed in previous sections, the levels of Easy, Medium, and Difficult are defined by identifying and pre-setting a numeric range, based on either method. The numeric range itself, can be changed based on the pattern of CC activation. For instance, the range of easy in the Thorndike method can be expanded from 1-10 to 1-12. The range of Medium and Difficult can in turn be shifted accordingly to 13-18 and 18-20. The shift of the numeric ranges corresponds to a shift of difficulty levels of words and phrases to display as determined by the user. Similar mechanisms of shifting the numeric ranges can be applied in the Dale & O'Rourke and Flesch methods as well.

If a user wishes to take more control of the learning process via CC, he or she can input an initial difficulty level, and use the Hint option to increase and decrease the difficulty level along the process.

The present method tracks a user's comprehension level by monitoring his or her pattern of CC usage in real time. A history of the usage can also be saved. For example, a user can pause the CC and retrieve a list of words or phrases of interest, and review corresponding explanations or even translations of them. Such an option can be programed into the Pause function of a normal remote control, or simply by adding a “Summary” button.

So far, we've discussed four general methods of classifying difficulty levels of words, phrases, sentences, and paragraphs in English only. It is entirely conceivable that other types of databases can be acquired and utilized for specific or added functionality. The Thorndike, Dale & O'Rourke databases serves only as exemplary illustrations for the present invention.

CC or subtitling is common for viewing media in different languages. Foreign movies, either from a DVD or from streaming, often come with options for a user to pick a language to display based on the user's needs or preferences. Databases in foreign languages can easily be added into the present system to serve similar functions.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for displaying closed captioning contents by a user, comprising the steps of:
receiving closed captioning contents;
calculating sub-difficulty levels of words from the closed captioning contents by comparing the words with at least one classification database;
grouping sub-difficulty levels based on preset ranges into difficulty levels; and
displaying words selected from closed captioning contents based on difficulty levels interactively adjusted by the user.

2. The method for displaying closed captioning contents of claim 1, wherein the difficulty levels of closed caption contents are calculated by:
identifying a rate level of each word as classified by a Thorndike Word Classification Database;
grouping rate levels into preset ranges of Easy, Medium, and Difficult; and
displaying corresponding words only within the preset ranges as interactively selected by the user.

3. The method for displaying closed captioning contents of claim 1, wherein the difficulty levels of closed caption contents are calculated by:
identifying a grade level of each word as classified by a Dale and O'Rourke Word Classification Database;
grouping grade levels into preset ranges of Easy, Medium, and Difficult; and
displaying corresponding words only within the preset ranges as interactively selected by the user.

4. The method for displaying closed captioning contents of claim 1, wherein the difficulty levels of closed caption contents are calculated by:
inputting a string of words and computing a Flesch Reading-Ease Score;
grouping Flesch Reading-Ease Scores into preset ranges of Easy, Medium, and Difficult; and
displaying corresponding string of words only within the preset ranges as interactively selected by the user.

5. The method for displaying closed captioning contents of claim 1, wherein the difficulty levels of closed caption contents are calculated by:
inputting a string of words and computing a first Flesch Reading-Ease Score;
identifying known phrases from the string of words by comparing to a dictionary;
computing a second Flesch Reading-Ease Score of the know phrases;
grouping Flesch Reading-Ease Scores into preset ranges of Easy, Medium, and Difficult; and
displaying corresponding string of words and phrases only within the ranges as interactively selected by the user.

6. The method for displaying closed captioning contents of claim 1, wherein the difficulty levels of closed caption contents are calculated by:
inputting a string of words and computing a first Flesch Reading-Ease Score;
grouping Flesch Reading-Ease Scores into a first preset ranges of Easy, Medium, and Difficult;
identifying a rate level of each word as classified by a Thorndike Word Classification Database;
grouping rate levels into a second preset ranges of Easy, Medium, and Difficult; and
displaying corresponding words only within the first and second preset ranges as interactively selected by the user.

7. The method for displaying closed captioning contents of claim 1, wherein the difficulty levels of closed caption contents are calculated by:
inputting a string of words and computing a first Flesch Reading-Ease Score;
grouping Flesch Reading-Ease Scores into a first preset ranges of Easy, Medium, and Difficult;
identifying a grade level of each word as classified by a Dale and O'Rourke Word Classification Database;
grouping grade levels into a second preset ranges of Easy, Medium, and Difficult; and
displaying corresponding words only within the first and second preset ranges as interactively selected by the user.

8. The method for displaying closed captioning contents of claim 1, wherein the step of displaying words selected from closed captioning contents further comprises:
tracking a user's frequency of activation of a Hint option to display more words over time; and
increasing and decreasing the difficulty levels of words to display from the closed caption contents based on frequency decrease and increase of the user's activation of the Hint option.

9. The method for displaying closed captioning contents of claim 1, wherein the step of displaying words selected from closed captioning contents further comprises:
tracking a user's frequency of activation of a Hint option to display more words over time;
calculating a sub-difficulty level at which the Hint option is activated at the highest frequency; and
displaying corresponding words at the sub-difficulty level and above.

10. The method for displaying closed captioning contents of claim 1, wherein the step of grouping difficulty levels into preset ranges further comprises:
tracking a user's frequency of activation of a Hint option to display more words over time; and
shifting the preset ranges of Easy, Medium, and Difficulty based on the frequency of activation of the Hint option.

11. The method for displaying closed captioning contents of claim 1, wherein the step of displaying words selected from closed captioning contents further comprises:
tracking a user's frequency of activation of a Hint option to display more words over time;
compiling a list of words displayed via the activation of the Hint option; and
providing a Summary function for the user to retrieve, to review and to translate the list of words.
